(19) United States
(12) Patent Application Publication
(10) Pub. No.: US 2006/0057256 A1
(43) Pub. Date: Mar. 16, 2006

(54) Method for manufacturing a compound food product and a compound food product

(76) Inventors: Pascal Couraud, Champcevinel (FR); Christine Martin-Rouas, Noisy Le Roi (FR); Marie-Pierre Queric, Perigueux (FR)

Correspondence Address: YOUNG & THOMPSON, 745 SOUTH 23RD STREET, 2ND FLOOR, ARLINGTON, VA, 22202, US

(21) Appl. No.: 11/225,036

(22) Filed: Sep. 14, 2005

(30) Foreign Application Priority Data
Sep. 15, 2004 (FR) 04 52057

(51) Int. Cl. A21D 13/00

(52) U.S. Cl. 426/94

(57) ABSTRACT

A method of making a food product includes—making a bread-type product by baking a dough, the composition of the dough being such that, after baking, the bread has a WA (water activity) that is higher than 0.90 and a water content comprised between 25 and 50%, making a garnish such as a cheese preparation, with a WA that is higher than 0.95 and a water content between 40 and 70% and associating the bread and the garnish in order to form the compound food product. When the food product is balanced, the bread and the garnish have a WA between 0.94 and 0.98 and a water content between 35 and 50%.

The invention relates to a method for manufacturing a compound food product as well as a compound food product obtained through implementation of the method.

In particular, the invention relates to a manufacturing method of a savoury product comprising a bread-type dough and a cheese-type garnish.

And yet, in this type of food products, one of the major problems that arise is the migration of water from the cheese to the bread, a phenomenon that is related to the respective WA (water activity) of the cheese and the bread, since the WA of cheese is higher than that of bread. This leads on the one hand to a moistening of the bread and, on the other hand, to a drying of the cheese, and thus to a Various solutions have been proposed for solving this problem.

First of all, document WO 99/02039 describes a compound food product that comprises dough with a cheese filling. However, this product is packaged pre-cooked, but not entirely cooked, and needs to be reheated before consumption. Due to its conservation in this pre-cooked state and the subsequent reheating, there is limited migration of water from the cheese to the dough. In addition, the reheating dries the bread. However, there is a growing demand among consumers for food products that can be consumed directly, for example, immediately after purchase, outside of the home. This food product is therefore not entirely satisfactory.

Furthermore, document GB 2 331 225 describes a compound food product comprising a sponge cake type dough and a creamy cheese garnish. In order to limit the migration of water between the garnish and the dough, this document provides a method for reducing the WA of the garnish. This results in the garnish losing its fresh and soft characteristics, which is detrimental to the texture and the taste of the end product. This is even more unpleasant for cheese preparation type garnishes. In addition, reducing the WA of the garnish results in greasy products, with considerable organoleptic and nutritional faults.

We also know, from document FR-A-2 769 471, a savoury compound food product comprising:
a standard biscuit comprising the following ingredients: water, baker's flour, egg, salt, and preservative;
and a filling that consists of melted cheese placed on the biscuit while hot
   in which the water exchanges between the filling and the biscuit are limited.

However, this document only relates to a specific food product that consists of a biscuit and melted cheese.

The aim of the invention is to produce a compound food product of the savoury snack type, comprising on one hand a bread-type product, mainly of the batch-bread or Viennese-bread type and, on the other hand, a cheese-type garnish such as a cheese preparation, this compound food product being suitable for cold storage with a duration of at least 45 days and directly consumable.

For this purpose, the invention provides a manufacturing method for a food product comprising stages that consist of:
making a bread-type product by baking a dough, the composition of the dough being such that, after baking, the bread has a WA (water activity) that is higher than 0.90 and a water content comprised between 25 and 50%;
making a garnish of the cheese preparation type, with a WA that is higher than 0.95 and a water content comprised between 40 and 70%;
associating the bread and the garnish so as to form the compound food product, the bread and the garnish having, in the balanced food product, a WA comprised between 0.94 and 0.98 and a water content comprised between 35 and 50%, the said food product being directly consumable.

According to a possible embodiment of the invention, the bread can be made using a dough with a certain composition so that, after baking, the bread has a water content comprised between 30 and 40% and/or a garnish is made that has a water content comprised between 50 and 60%.

For example, the food product is made by injecting the garnish into the bread or by placing the garnish on top of the bread.

According to a second aspect, the invention relates to a compound food product obtained by implementing the method described above, comprising at least:
a first part made from a bread-type product obtained by baking a dough and with a WA that is higher than 0.90 and a water content comprised between 25 and 50%.
a second part made from a cheese-preparation-type garnish, with a WA that is higher than 0.95 and a water content comprised between 40 and 70%;
   said first and second parts being associated with each other, the food product being such that bread and garnish have, in the balanced food product, a WA comprised between 0.94 and 0.98 and a water content comprised between 35 and 50%, said food product being directly consumable.

The dough can also comprise means for slowing the retrogradation of its starch and/or moist ingredients that are likely to release water after baking.

The garnish can comprise at least 90% of a mix of cream, white cheese and milk.

The compound food product can have a weight comprised between 20 and 70 g, the proportion of the weight that corresponds to the garnish being comprised between 20 and 40%.

Finally, according to a third aspect, the invention relates to a set comprising such a compound product and a packaging containing said food product in a modified environment, said packaging being hermetically sealed and made from a material that provides an excellent barrier against water and oxygen.

Further objectives and advantages of the invention will become apparent from the following description, made in reference to the appended drawings, in which:

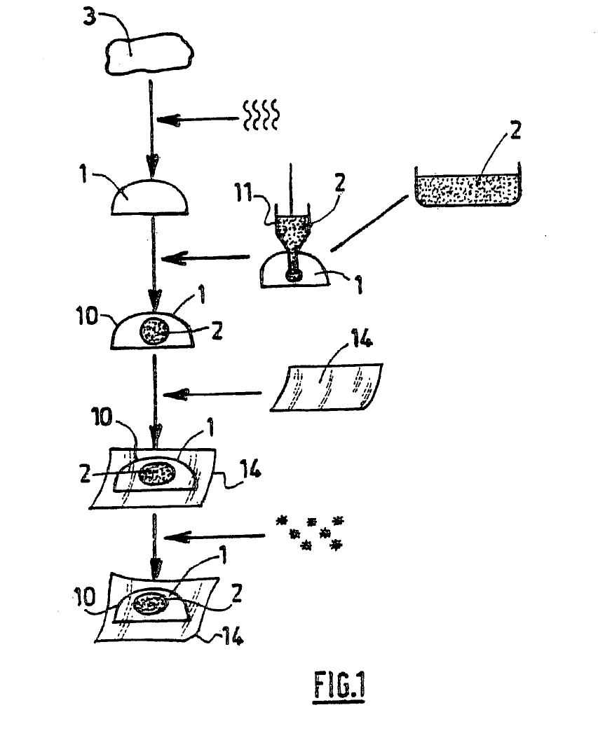

FIG. 1 is a diagram showing the various steps of the process for manufacturing a food product according to the invention, comprising bread and a cheese preparation, also showing the evolution of the food product throughout the process, said product being shown in a cross-section view;

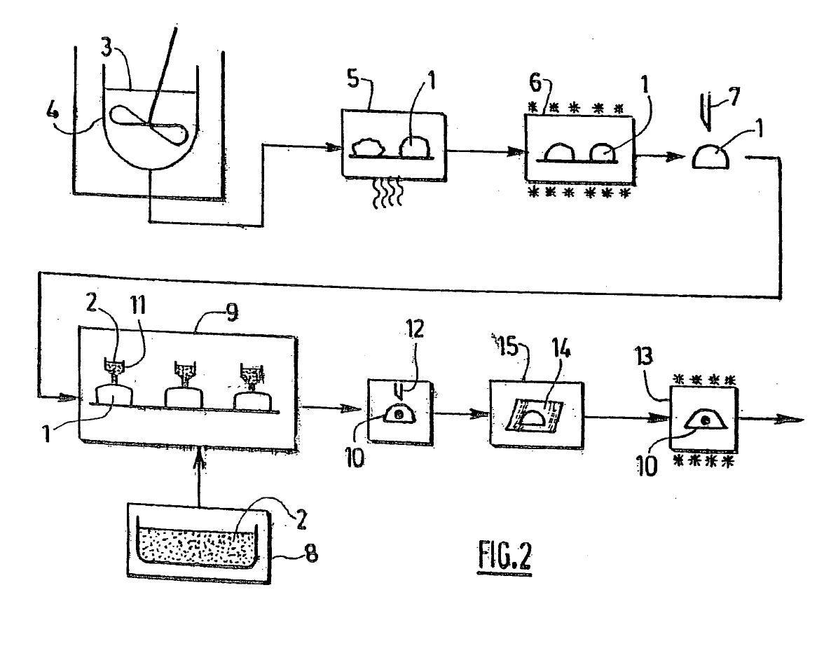

FIG. 2 is a diagram showing a facility for implementing the process shown in FIG. 1;

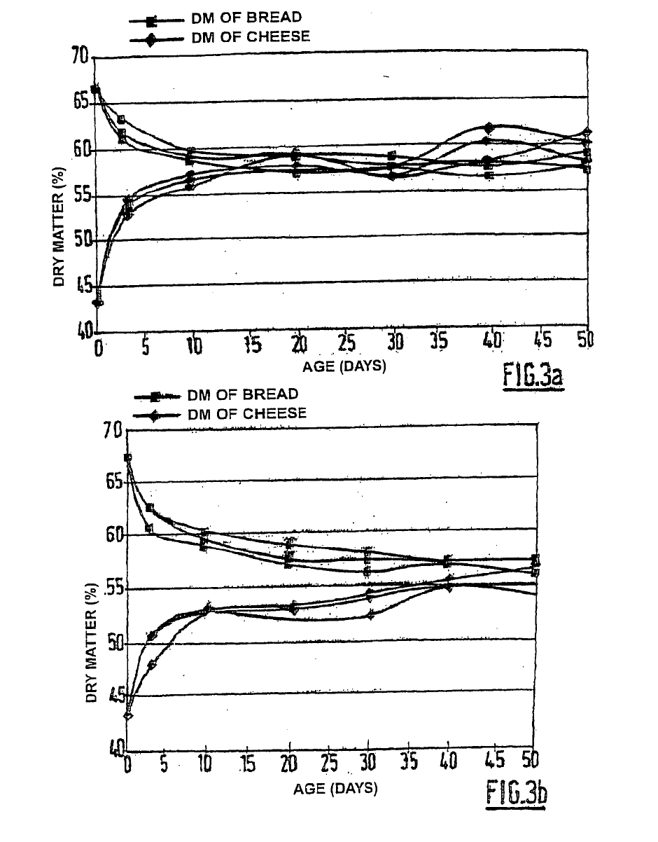

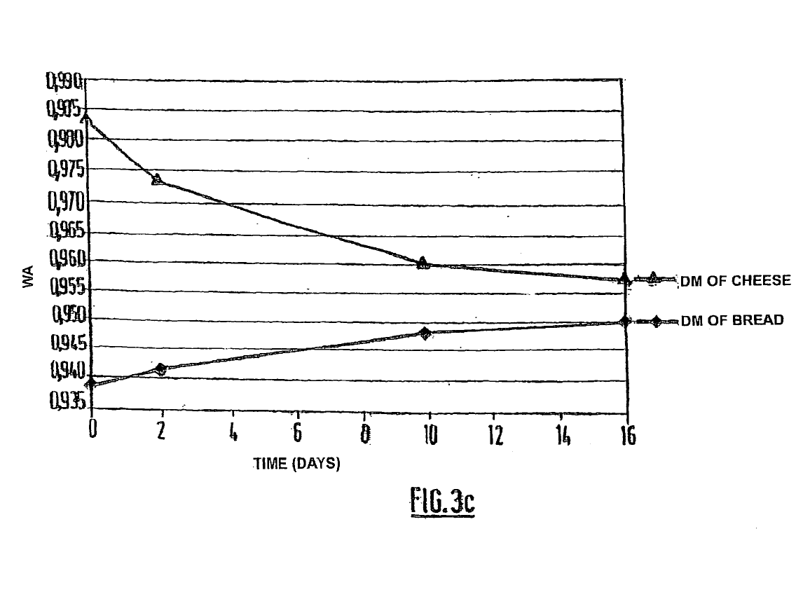

FIGS. 3a and 3b are diagrams that show the evolution of the dry matter in the bread and the cheese preparation over time, in a food product obtained by implementing the process shown in FIG. 1, for two different types of products;

FIG. 3c is a diagram showing the evolution of the WA of the bread and the cheese preparation over time, in a food product obtained by implementing the process shown in FIG. 1;

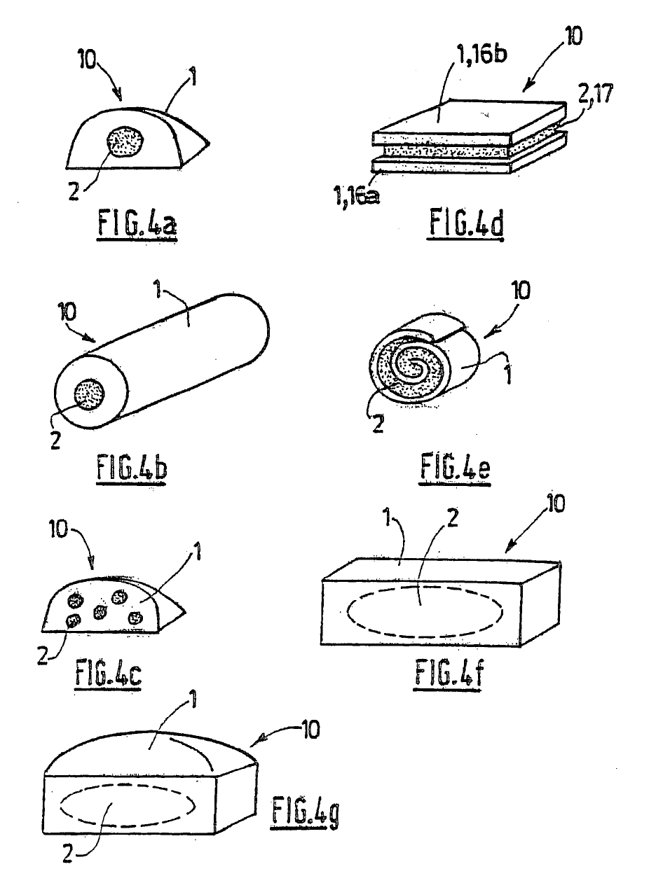

FIGS. 4a to 4g show various food products obtained by implementing the process shown in FIG. 1.

We shall refer initially to FIGS. 1 and 2, which respectively show the process for manufacturing the compound food product made up of bread and a cheese preparation, and the required manufacturing facility.

The first step is to separately produce the bread 1 and the garnish 2, which will be associated in a second step.

The bread 1 is made from a dough 3 or, alternatively, from frozen pre-baked bread, which is also made from the same type of dough. The dough 3 comprises essentially flour, water, yeast and salt.

The dough can comprise a single type of bread flour. Alternatively, the flour can be a blend of several bread flours (wheat, rye, etc.). It can include all the required additives that are generally used and authorised (gums, enzymes, fat, fibre, protein, etc.) to give the bread the softness expected throughout the shelf life of the food product and at the recommended storage temperature for the said product (4 to 6° C.). This formulation makes it possible to limit the retrogradation of the starch, which is normally speeded up by cold and, thus, to slow the staling phenomenon in the bread 1.

In addition, the flour may contain added preservatives, such as propionate, as well as additives or ingredients to add flavour, colour and decoration, insofar as these additions do not reduce the moisture of the bread after baking.

The dough 3 is formulated so that the bread has a high water content after baking. For this purpose, the dough may also contain moist ingredients that are able to release water after baking (e.g. raw grated carrot). Thus, the basic approach of the project is to increase the WA of the bread so that it is closer to the WA of the garnish, and thus to limit the migration of water from the garnish to the bread.

The dough 3 is that used for making bread, mainly of the batch-bread or Viennese-bread type, and not the type of dough typically used for making biscuits or cake.

The various ingredients that make up the dough 3 are mixed and kneaded in a kneading machine 4. The dough 3 is then carried to a baking facility, such as an oven 5, to produce the bread 1. For example, the bread 1 can be made in a mould.

Depending on the dough used, it is possible to obtain bread with various colours, tastes and/or appearances (white, brown or black bread, bread with grains or bran, with decorations, etc.). It can be, for example, batch bread or Viennese bread.

After baking, the bread 1 is cooled down or refrigerated in a suitable enclosure 6. If required, it can be cut to the desired shape and sizes using an adapted tool 7. For example, the bread 1 can be sliced along the middle.

The garnish 2 comprises cheese or a cheese preparation, made in a facility 8 according to a suitable method.

The cheese preparation is a milk base mix (cream, curdled milk) with additives (texturising agents, milk protein, preservatives) and additional ingredients (taste and texture markers) and can have the following composition:
approximately 30% fat;
approximately 60% water;
added milk protein;
salt;
a texturising agent;
optionally a preservative (for example, sorbate).

In addition, the cheese preparation may contain one or several WA depressants, such as lactose or glycerol, with a slightly sweet taste, in a ratio of around 3%.

Thus, the WA of the cheese preparation is reduced while the WA of the bread is increased, in order to produce an even more satisfactory food product. Nevertheless, the reduction of the WA of the cheese preparation is very limited, due to nutritional and organoleptic considerations.

The cheese preparation can also be expanded, whipped and/or contain flavourings.

The formulation of the garnish 2 has the aim of obtaining a low level of free water while conserving the consistence and organoleptic qualities of a fresh spreadable cheese.

The garnish 2 comprises mainly, or even exclusively, a cheese preparation and not for example a mix of cheese and breadcrumbs, or an equivalent element, which would have the function of considerably modifying the water content properties of the garnish in order to solve the water transfer problems.

Once the bread 1 and the garnish 2 have been produced, as described above, they are associated with each other in a garnishing facility 9. The temperature conditions used make it possible to facilitate garnishing while guaranteeing optimum preservation of the product.

According to a first alternative, the garnish 2 is injected into the bread 1, such as to obtain a filled food product 10. For this purpose, the garnish 2 in liquid, thick or viscous state is inserted into a dispensing injector 11, which is inserted into the bread 1 and injects the desired amount of garnish 2 into the bread 1. The garnish 2 can be injected in the bread 1 from the side, from the top or from the bottom, as required.

According to a second alternative, not shown, the garnish 2 is placed on top of the bread 1 (placing a layer of garnish 2 on the bread 1) in order to obtain a multilayer food product 10.

If required, the compound food product 10 thus obtained can be cut to the desired shape and size using an adapted tool 12.

Then, the food product 10 is placed in a hermetic packaging 14, in a packaging facility 15.

Finally, the food product 10 is cooled in a suitable enclosure 13, to a storage temperature of less than 8° C., and preferably comprised between 4 and 6° C., and then it is carried to a storage area before delivery to shops, where the consumer can purchase it.

The packaging 14 can be a box or a bag containing several food products 10. The food products 10 can also be packaged individually. In order to facilitate the organoleptic and microbiological conservation of the food product 10, the packaging 14 must meet specific requirements in terms of water-barrier and oxygen-barrier properties. The packaging will preferably be watertight and made up of a material that provides an excellent barrier against water and oxygen. In addition, the residual oxygen content inside the packaging 14 must be very low during the storage of the product 10 (lower than 1%, for example) . For this purpose, the product 10 can be packaged in a modified environment (a protective gas such as nitrogen or nitrogen/CO₂).

It should be noted that the facility shown in FIG. 2 can comprise three distinct units, the first intended for making the bread, the second intended for making the garnish and the third intended for associating the bread and the garnish, the three units not necessarily being located in the same room.

The product can be consumed directly or stored by the consumer at a temperature comprised between 4 and 6° C., for at least 45 days. In addition, the product can be kept for around 12 hours at room temperature before being consumed.

We will now deal with FIGS. 3a, 3b and 3c.

FIGS. 3a and 3b show the evolution of the dry matter of the bread and the cheese preparation over time for a compound food product stored at a temperature of around 10° C.:
a compound food product comprising bread of the rectangular whole-wheat type and a filling of the basic type flavoured with garlic and fine herbs (FIG. 3a);
a compound food product comprising a round piece of white bread and a cheese of the natural basic type.

The various curves shown in the same figure correspond to different bread formulations (modifying the additives).

As regards FIG. 3c, it represents the evolution of the WA of the bread and the cheese preparation over time, in the case of a compound food product comprising a rectangular piece of whole-wheat bread and a filling of the basic type flavoured with garlic and fine herbs, at a storage temperature of approximately 10° C.

The curves in the figure show the evolution and the balance of the water content between the bread and the cheese preparation. The water transfer from the cheese preparation to the bread continues until a balance is reached after around 10-15 days.

After baking and before being associated with the garnish, the bread has a water content comprised between 30 and 40% (or dry matter comprised between 60 and 70%, mainly 67%), while the garnish has, before being associated with the bread, a water content comprised between 50 and 60% (or dry matter comprised between 40 and 50%, mainly 43%).

Water transfer exists, but it is limited by the formulation of the bread and the cheese preparation, which makes it possible to obtain a bread/cheese texture that is pleasant when balanced and when cold.

In the production examples, the evolution of the WA can be as follows:

| | Before | In the compound |
|---|---|---|
| | association | product, after 13 days |
| Bread: round white | 0.938 | 0.963 |
| Cheese: basic natural | 0.983 | 0.972 |

Particularly, the evolution the WA can be as follows (in the case of FIG. 3c):

| | Before | In the compound |
|---|---|---|
| | association | product, after 15 days |
| Bread: rectangular whole-wheat | 0.938 | 0.950 |
| Cheese: basic flavoured | 0.983 | 0.958 |
| with garlic and fine herbs | | |

It should be noted that in order to achieve this result, it is not necessary to provide a layer of a water-barrier product placed between the bread and the cheese, which would have the function of “isolating” the bread from the cheese, in order to limit, or even prevent, migration of the water from one to the other.

Finally, as regards FIGS. 4a to 4g, we will describe various possible shapes of the food product 10.

In FIGS. 4a and 4c (in perspective and cross-section view), the compound food product is shown in the shape of a round ball of bread 1, possibly with a flattened base, filled with one or several inclusions of garnish 2. The bread can also come in the shape of a long roll, of a substantially parallipipiedal loaf (FIG. 4f) of the mini-batch-bread type obtained in a closed baking mould, or even of the mini-cake type (FIG. 4g) obtained in a baking mould with no cover, in order to present a substantially parallelipipedal shape and a rounded top face.

In FIG. 4b, the compound food product (shown in a cross-section) is presented in the form of a cylinder of bread 1 filled with one inclusion of garnish 2 that is substantially cylindrical in shape. Several inclusions may also be planned.

As an alternative, the compound food product comprises a first slice 16a of bread 1 and, on top of it, a layer 17 of garnish 2. Particularly, as shown in FIG. 4d, the compound food product also comprises a second slice 16b of bread 1 placed so that the garnish 2 is inserted between the first and second slices (“sandwich” type).

Optionally, it is possible to plan a structure of the “millefeuille” type, alternating several layers of bread with several layers of garnish.

In FIG. 4e, the compound food product is presented in the shape of a roll comprising a layer of bread 1 and a layer of garnish 2 forming two overlapping spirals.

For making the products shown in FIGS. 4d and 4e, the layers of bread are previously cut to the desired sizes, or else, the food product is cut to the desired dimensions once it has been made.

Next we will present 3 production examples of the food product according to the invention.

### EXAMPLE 1

bread type: white batch bread or Viennese bread, wheat flour

bread format: round roll (20 to 30 g dough roll) baked on a tray or in moulds

formulation of the bread: use of vegetable fibres (carrot, tomato, pumpkin, etc.) to bind the water. Possibility of adding milk minerals, flavours and or markers (for example, ham flavouring and pieces, etc.)

water characteristics of the bread before use:
water content of the bread: 36-37%
WA of the bread: 0.95-0.96

formulation of the garnish:
cream, white cheese and milk: between 90 and 93%
milk protein: 2% to 3%
salt: around 1%
glycerol: around 3%
thickeners: 0.2% to 0.05%
pasteurised and chilled mix

characteristics of the garnish before use:
fat content: minimum 28%
WA: 0.98-0.99
dry matter: maximum 42%
water content: maximum 58%
protein content: minimum 5%
pH: 4.80-5.40

assembly method: injection of the garnish into the bread (in the side or the bottom of the product)

bread/cheese ratio: the cheese is added to 20 to 40% of the weight of the end product (weight of the end product 30 to 50 g).

packaging method: rigid thermally moulded packaging, heat-sealed, in a modified environment consisting of nitrogen or nitrogen/CO₂ (50/50 or 80/20, for example)

water characteristics of the food product in balance:
balance of the water contents at around 20 days
water content of the garnish in balance: 46%
water content of the bread in balance: 43-44%
WA: 0.949-0.956

### EXAMPLE 2

bread type: batch bread or Viennese bread (brown batch) Blend of flours (such as wheat and rye)

bread format: rectangular-shaped bread baked in a mould that can be closed or not (such as a batch-bread mould). Weight of the dough roll: 20 g to 40 g.

formulation of the bread: use of non-dehydrated bits (vegetables, meat, etc.) that allow the bread to retain its water content during storage. Possibility of adding inner and outer markers (grains such as sesame seeds, flax, poppy seeds, sunflower seeds, gourd, etc.)

water characteristics of the bread before use:
water content of the bread: 33-35%

formulation of the garnish: as in example 1, with the possibility of adding flavouring ingredients such as herbs and spices (such as garlic, onion, parsley, Provence herbs, pepper, basil, paprika, etc) or vegetables (tomato, pumpkin, etc.).

characteristics of the garnish before use: identical to example 1

assembly method: injection of the garnish into the bread (in the side or the bottom of the product)

bread/cheese ratio: the cheese is added to 20 to 40% of the weight of the end product (weight of the end product 30 to 60 g).

packaging method: flexible packaging such as hermetically sealed bags in a modified environment, such as nitrogen or nitrogen/CO₂ (50/50 or 80/20, for example) and, possibly, 2% of 70% alcohol sprayed over the end product.

water characteristics of the food product in balance:
balance of the water contents at around 20 days
water content of the garnish in balance: 42-43%
water content of the bread in balance: 42-43%
WA: 0.951-0.958

### EXAMPLE 3

bread type: batch bread or Viennese bread (brown batch) Wheat four with colour and flavour additives such as malt extracts or deactivated rye ferments.

bread format: rectangular-shaped bread baked in a closed mould (such as a batch-bread mould) . Weight of the dough roll, 20 g to 40 g.

formulation of the bread: added inner and outer markers (grains such as sesame seeds, flax, poppy seeds, sunflower seeds, gourd, etc.)

water characteristics of the bread before use:
water content of the bread: 33-35%

formulation of the garnish: as in example 2

characteristics of the garnish before use: identical to example 1

assembly method: filling by superimposing layers (bread sliced in two down the middle). 1 layer of bread+1 layer of garnish+1 layer of bread or 1 layer of bread+1 layer of garnish+product coating

bread/cheese ratio: the cheese is added to 20 to 40% of the weight of the end product (weight of the end product: 30 to 60 g).

packaging method: flexible packaging such as hermetically sealed bags in a modified environment, such as nitrogen.

water content characteristics of the food product in balance:
balance of the water contents at around 20 days
water content of the garnish in balance: 42-43%
water content of the bread in balance: 42-43%
WA: 0.951-0.958

For each of these three examples, the product needs to be refrigerated (4 to 6° C.) for a minimum of 45 days. It conserves the organoleptic characteristics of the bread (soft, limited staleness) and the garnish (moisture, freshness), as well as the bacteriological stability.

1. A manufacturing process for a compound food product (10) comprising the steps of:
making a bread-type product (1) by baking dough (3), the composition of the dough being such that, after baking, the bread (1) has a WA (water activity) that is higher than 0.90 and a water content between 25 and 50%;
making a garnish (2) that has a WA that is higher than 0.95 and a water content between 40 and 70%;
associating the bread (1) and the garnish (2) in order to form the compound food product (10), the bread (1) and the garnish (2) having, in the balanced food product, a WA between 0.94 and 0.98 and a water content between 35 and 50%, the food product being directly consumable.

2. A method according to claim 1, characterised in that the bread (1) is made from a dough with a composition such that, after baking, the bread (1) has a water content comprised between 30 and 40%.

3. A method according to claim 1, characterised in that a garnish (2) is made, which has a water content comprised between 50 and 60%.

4. A method according to claim 1, characterised in that the food product (10) is made by injecting the garnish (2) into the bread (1).

5. A method according to claim 1, characterised in that the food product (10) is made by superimposing the garnish (2) and the bread (1).

6. A method according to claim 1, characterised in that, after the step in which the bread (1) and the garnish (2) are associated, the made food product (10) is chilled to a temperature that is lower than 8° C.

7. A method according to claim 1, characterised in that it comprises a stage in which the bread (1) is cut before associating the garnish (2), and/or a stage in which the food product (10) is cut.

8. A method according to claim 6, characterised in that, after cutting and before refrigeration, the food product (10) is packaged in a packaging (14) which is sealed hermetically and is made from a material that provides an excellent barrier against water and oxygen.

9. A method according to claim 6, characterised in that, after cutting and before refrigeration, the food product (10) is packaged in a packaging (14) that is sealed in a modified environment.

10. A compound food product comprising:
a first part made from a bread-type product (1) obtained by baking dough, with a WA that is higher than 0.90 and a water content comprised between 25 and 50%;
a second part made up of a cheese-preparation-type garnish (2), with a WA that is higher than 0.95 and a water content comprised between 40 and 70%;
the said first and second parts being associated with each other, the food product (10) being such that the bread (1) and the garnish (2), in the balanced food product, have a WA comprised between 0.94 and 0.98 and a water content comprised between 35 and 50%, the said food product being directly consumable.

11. A compound food product according to claim 10, characterised in that the bread (1) has, after baking and before being associated with the garnish (2), a water content comprised between 30 and 40%.

12. A compound food product according to claim 10, characterised in that the bread (1) is of the batch-bread or Viennese-bread type.

13. A compound food product according to claim 10, characterised in that the bread (1) is essentially made from baker's flour or a blend of baker's flours, water, yeast and salt.

14. A compound food product according to claim 10, characterised in that the dough also comprises means for slowing the retrogradation of the starch and/or of the moist ingredients that may release water after baking.

15. A compound food product according to claim 10, characterised in that the garnish (2) has, before association with the bread (1), a water content comprised between 50 and 60%.

16. A compound food product according to claim 10, characterised in that the garnish (2) comprises at least 90% of a mix of cream, white cheese and milk.

17. A compound food product according to claim 10, characterised in that the garnish (2) has the following composition:
cream, white cheese and milk: between 90 and 93%
milk protein: 2 to 3%
salt: around 1%
glycerol: around 3%
thickeners: 0.2 to 0.05%

18. A compound food product according to claim 10, characterised in that the garnish (2) also comprises flavouring ingredients and/or vegetables.

19. A compound food product according to claim 10, characterised in that its weight is comprised between 20 and 70 g, the proportion of which that corresponds to the garnish (2) being comprised between 20 and 40%.

20. A compound food product according to claim 10, characterised in that it is presented in the shape of a round roll of bread (1), a long roll of bread (1), a substantially parallelipipedal miniature batch bread or a substantially parallelipipedal mini cake with a rounded top face, the said food product being filled with one or several inclusions of garnish (2).

21. A compound food product according to claim 10, characterised in that it is presented in the shape of a bread cylinder (1) made from one or several inclusions of garnish (2) with a substantially cylindrical shape.

22. A compound food product according to claim 10, characterised in that it is presented in the shape of a roll comprising a layer of bread (1) and a layer of garnish (2) forming two overlapping spirals.

23. A compound food product according to claim 10, characterised in that it comprises a first slice (16a) of bread (1) and, on top, a layer (17) of garnish (2).

24. A compound food product according to claim 23, characterised in that it also comprises a second slice (16b) of bread (1) placed so that the garnish (2) is placed between the first and second slices.

25. A set made up of a compound food product (10) according to claim 10 and a packaging (14) containing said food product in a modified environment, said packaging being hermetically sealed and made from a material that provides an excellent barrier against water and oxygen.
